(19) United States
(12) Patent Application Publication
(10) Pub. No.: US 2023/0234757 A1
(43) Pub. Date: Jul. 27, 2023

(54) CONTAINER ASSEMBLIES INCLUDING POP-TOP CAPS

(71) Applicant: 3E Biotech Inc., Newport Beach, CA (US)

(72) Inventors: Habib Rostami, Irvine, CA (US); Steve Hwang, San Rafael, CA (US)

(73) Assignee: 3E Biotech Inc., Newport Beach, CA (US)

(21) Appl. No.: 18/101,476

(22) Filed: Jan. 25, 2023

Related U.S. Application Data
(60) Provisional application No. 63/303,359, filed on Jan. 26, 2022.

(51) Int. Cl. B65D 43/16; B65D 50/00; B65D 65/46

(52) U.S. Cl. CPC B65D 43/162; B65D 50/00; B65D 65/466; B65D 2543/00462; B65D 2543/00935

(57) ABSTRACT

A pop-top container assembly is provided. The assembly includes a pop-top cap and a container. The pop-top cap includes a base portion defining an opening having an inner surface. The pop-top cap further includes a cap portion pivotably coupled to the base portion and pivotable between an open position and a closed position. The container has an outer surface and defines an internal cavity with the outer surface depressible between a relaxed position and a depressed position. The base portion includes a lip extending from the inner surface and the cap portion includes a flange extending from the cap portion. The flange and the lip engage each other when the cap portion is in the closed position to secure the cap portion to the base portion. To this end, the pop-top cap and the container cooperate to disengage the flange and the lip from each other when the outer surface is depressed from the relaxed position to the depressed position.

This application claims the benefit of priority to U.S. patent application with the Ser. No. 63/303,359, which was filed on Jan. 26, 2022, the contents of which is incorporated by reference herein in its entirety.

### FIELD OF THE INVENTION

The field of the invention relates to container assemblies including pop-top caps.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

There is an increasing awareness of the need to protect children from inadvertently gaining access to medications, especially prescribed medications. In contrast, there is an increasing awareness of the necessity to provide containers for prescribed medications that are readily and easily opened by an adult, that is, any person having the cognitive ability to understand the instructions for opening a pill container, which requires certain manipulation and manual dexterity. Such persons are assumed to have the ability to understand that the act of opening a pill container to gain access to the prescribed medication is a deliberate action, and is only undertaken when there is a necessity to attain access to the prescribed medication in the container.

There are several conventional “child-resistant” containers in the market, which are generally used in filling prescriptions, where the prescription requires that the pharmacist dispense one or more of a plurality of pills, tablets, gel-caps, capsules, or the like. For example, the container may include a “push-and-turn” closure for pill containers, or an “arrow-alignment” closure for the containers.

The “push-and-turn” system for containers conventionally refers to an assembly in which the closure or cap for the container must be pushed axially downwardly and rotated at the same time to open the container. The “arrow alignment” system for containers conventionally refers to an assembly in which an arrow on the closure or cap must be aligned with an arrow on the container, such as one which is embossed on the container, in order to open the container. However, these containers are often complicated for adults to use.

Conventional container assemblies of the type where the cap or closure is integral with the container may have a fixed protrusion (also referred to as a “thumb tab”) attached to the cap that is configured to assist in the opening of the cap. More typically, this fixed protrusion is opposite the hinge, and thus, acts as a lever to allow the intended user to open the container when a sufficient force is applied under the fixed protrusion. However, these containers can be opened by a child.

Thus, even though various container assemblies and methods of forming the same are known in the art, all or almost all of them suffer from several drawbacks. Therefore, there remains a need for improved container assemblies and methods of forming the same.

### SUMMARY OF THE INVENTION

The inventive subject matter is directed to various container assemblies and methods of forming the same.

In one aspect of the inventive subject matter, the inventors contemplate a pop-top container assembly. The assembly includes a pop-top cap and a container. The pop-top cap includes a base portion defining an opening having an inner surface. The pop-top cap further includes a cap portion pivotably coupled to the base portion and pivotable between an open position and a closed position. The container has an outer surface and defines an internal cavity with the outer surface depressible between a relaxed position and a depressed position.

It is contemplated that the base portion includes a lip extending from the inner surface and the cap portion includes a flange extending from the cap portion. The flange and the lip engage each other when the cap portion is in the closed position to secure the cap portion to the base portion. To this end, the pop-top cap and the container cooperate to disengage the flange and the lip from each other when the outer surface is depressed from the relaxed position to the depressed position.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view illustrating an embodiment of an assembly.

FIG. 2 is another perspective view illustrating an embodiment of the assembly of FIG. 1.

FIG. 3 is another perspective view illustrating an embodiment of the assembly of FIG. 1.

FIG. 4 is another perspective view illustrating an embodiment of the assembly of FIG. 1.

FIG. 5 is another perspective view illustrating an embodiment of the assembly of FIG. 1.

### DETAILED DESCRIPTION

A pop-top container assembly is provided herein. The assembly may be utilized as a pill container (e.g. for medications). However, it is to be appreciated that the assembly may be utilized to contain any other substance. The assembly may have any shape that is suitable for storing medicaments. In some embodiments, the assembly is child-resistant. The phrase “child-resistant” means that when the assembly is evaluated by a group of five year old children, the child-resistant assembly cannot be opened by at least 85% of those children prior to a demonstration to them of the proper means of opening the assembly, and still cannot be opened by at least 80% of those children after they receive a demonstration of the proper manner for opening the assembly. In the case where a child-resistant assembly is provided to a test group of adults, at least 90% of those adults must be capable of opening the assembly. Where the assembly is designed so that it may be re-closed, it can be re-closed by at least 90% of those adults but still cannot be opened by at least 85% of children to whom no demonstration of the proper method of opening the assembly has been given, nor by 80% of those children after a demonstration has been made.

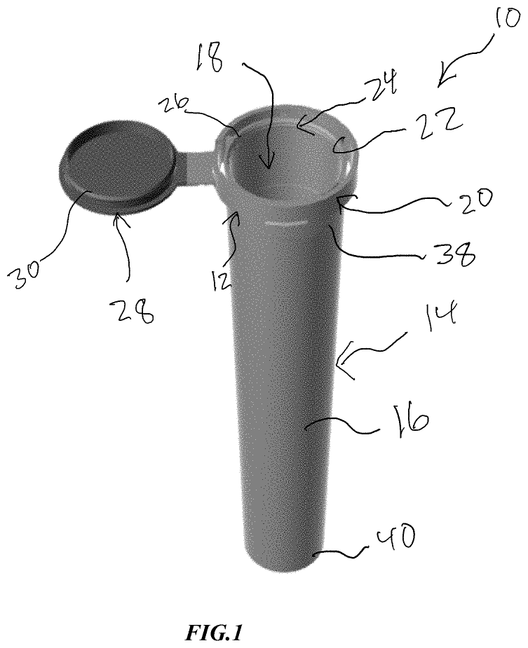

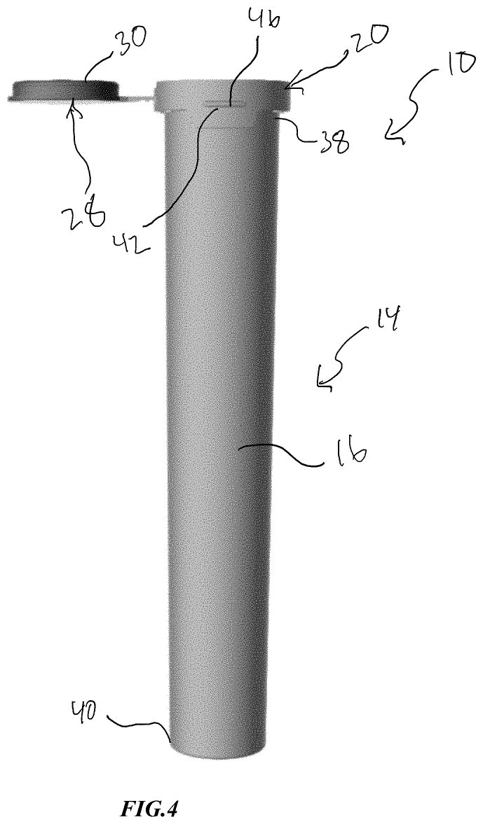

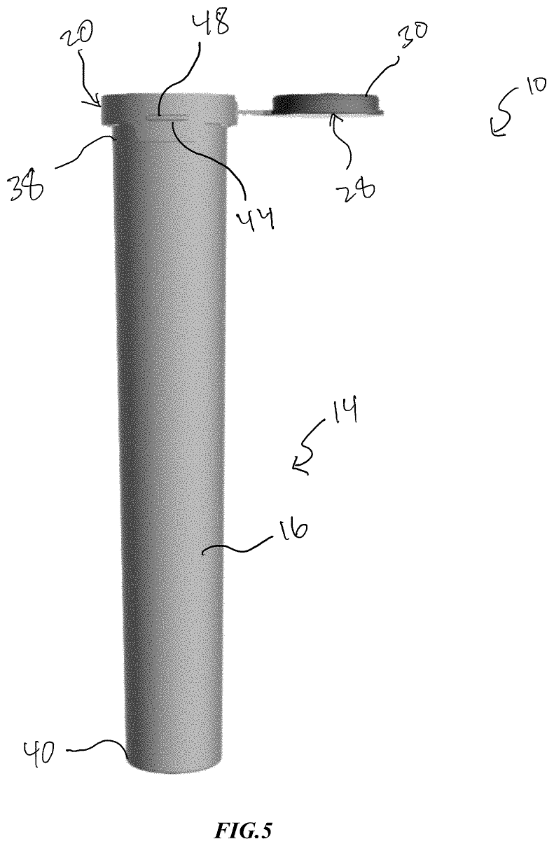

FIGS. 1-5 are perspective views illustrating an embodiment of the assembly 10. The assembly 10 includes a pop-top cap 12 and a container 14, which are integrally coupled to each other. The pop-top cap 12 may be coupled to the container 14 in any manner known in the art for positioning between an open position and a closed position and adapted to cover the opening while in the closed position. The container 14 has an outer surface 16 and defines an internal cavity 18. The pop-top cap 12 may be utilized to seal the internal cavity 18 from the environment.

With particular reference to FIG. 1, the pop-top cap 12 comprises a cap portion 28 and a base portion 20. The base portion is integrally coupled or connected to the container 14. The pop-top cap 12 includes a base portion 20 having an inner surface 22 that defines an opening 24. The base portion 20 includes a lip 26 extending from the inner surface 22. The pop-top cap 12 further includes a cap portion 28 pivotably coupled to the base portion 20. The cap portion 28 is pivotable between an open position and a closed position. The cap portion 28 includes a flange 30 extending from the cap portion 28. It is contemplated that the flange 30 and the lip 26 engage each other when the cap portion 28 is in the closed position to secure the cap portion 28 to the base portion 20.

In various aspects, the outer surface 16 is depressible between a relaxed position and a depressed position. To this end, the pop-top cap 12 and the container 14 cooperate to disengage the flange 30 and the lip 26 from each other when the outer surface 16 is depressed from the relaxed position to the depressed position. It is contemplated that depression of the outer surface 16 to disengage the flange 30 from the lip 26 renders the assembly 10 child-resistant. The pop-top cap 12 and the container 14 may cooperate in any manner known in the art to permit the flange 30 to disengage from the lip 26 when the outer surface 16 is depressed. In various embodiments, the outer surface may be depressed from the relaxed position to the depressed position in the presence of a force by a user that is in an amount of at least 1 newton (N), at least 5 N, at least 10 N, at least 15 N, at least 20 N, at least 25 N, at least 30 N, at least 35 N, at least 40 N, at least 45 N, at least 50 N, at least 55 N, at least 60 N, at least 65 N, at least 70 N, at least 75 N, at least 80 N, at least 85 N, at least 90 N, at least 95 N, or at least 100 N, and even more. In various embodiments, the base portion 20 is deformed relative to the cap portion 28 such that the flange 30 disengages from the lip 26.

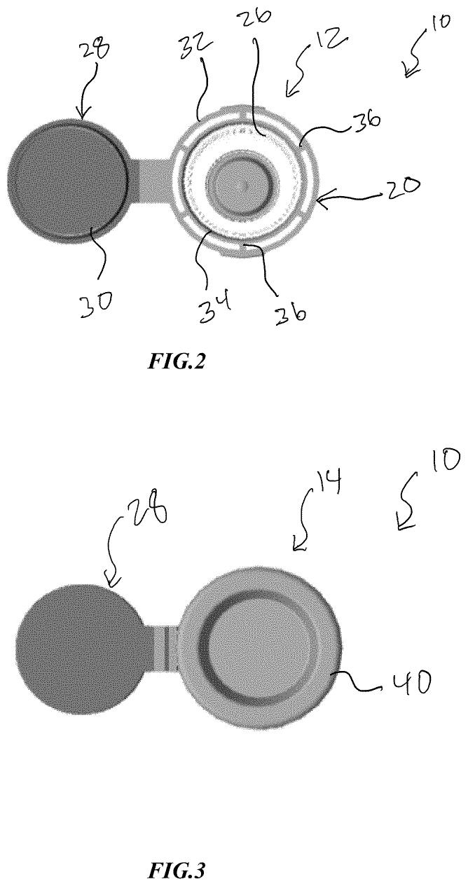

With particular reference to FIG. 2, the base portion 20 includes an outer ring 32, an inner ring 34, and a plurality of linkages 36 coupling the outer ring 32 and inner ring 34 together. In various embodiments, the plurality of linkages 36 is adapted to flex in the presence of a pre-determined amount of force applied to the inner ring 34 when the outer surface 16 of the container 14 is depressed from the relaxed position to the depressed position. The pre-determined amount of force applied to the inner ring 34 resulting from depression of the outer surface 16 may be in an amount of at least 1 newton (N), at least 5 N, at least 10 N, at least 15 N, at least 20 N, at least 25 N, at least 30 N, at least 35 N, at least 40 N, at least 45 N, at least 50 N, at least 55 N, at least 60 N, at least 65 N, at least 70 N, at least 75 N, at least 80 N, at least 85 N, at least 90 N, at least 95 N, or at least 100 N, and even more. The inventors have surprisingly found that the arrangement of the outer ring 32, the inner ring 34, and the linkages 36 as disclosed herein provides several unexpected benefits. Advantageously this arrangement of the rings in the base portion improves the child resistant feature of the pop-top container assembly because it isolates the pinch point and makes the opening method more effective. At the same time, the above disclosed arrangement of the rings in the base portion makes the pop-top container assembly readily and easily openable by an adult. Finally, this specific arrangement allows for compliance with biodegradability.

In various embodiments, the lip 26 of the base portion 20 extends from the inner ring 34. When the container 14 is depressed with the force by the user, the depression of the container 14 applies the pre-determined amount of force to the inner ring 34 and thus results in flex of the plurality of linkages 36 thereby allowing the inner ring 34 to deform relative to the outer ring 32. To this end, the flange 30 disengages from the lip 26 when the inner ring 34 is deformed without substantially deforming the outer ring 32 and thereby allows the cap portion 28 to move from the closed position to the open position. The term “substantially” as utilized herein with reference to the deformation of the outer ring 32 means that any diameter of the outer ring 32 increases or decreases, when the container is in the depressed position relative to the relaxed position, in an amount of no greater than 20%, no greater than 15%, no greater than 10%, no greater than 5%, no greater than 4%, no greater than 3%, no greater than 2%, or no greater than 1%, and even less.

With particular reference to FIGS. 2-5, the container 14 has a first end 38 and a second end 40 opposite the first end 38. The outer surface 16 is disposed between the first end 38 and the second end 40. In various embodiments, the base portion 20 of the pop-top cap 12 is directly coupled to the container 14 adjacent the first end 38. In exemplary embodiments, the outer ring 32 and the inner ring 34 of the base portion 20 are directly coupled to the container 14 adjacent the first end 38. In these and other embodiments, the outer ring 32 defines a first void 42 and a second void 44 spaced from each other. The outer surface 16 of the container 14 includes a first tab 46 and a second tab 48 spaced from each other and extending away from the outer surface 16. The first and second voids 42, 44 and the first and second tabs 46, 48 may be adapted to engage each other for securing the pop-top cap 12 to the container 14. However, it is to be appreciated that the pop-top cap 12 may be coupled to the container 14 in any manner known in the art.

In certain embodiments, the container 14 has a length extending between the first end 38 and the second end 40. The length may be in an amount of from 1 to 500 centimeter(s) (cm), from 10 to 400 cm, from 20 to 300 cm, from 50 to 200 cm, or from 100 to 150 cm. However, it is to be appreciated that the container 14 may have any length so long as the flange 30 and the lip 26 disengage from each other when the outer surface 16 is depressed from the relaxed position to the depressed position.

In various embodiments, the container 14 has a generally circular cross-section transverse to the length. The cross-section may have a first diameter adjacent the first end 38 in an amount of from 0.1 to 100 cm, from 1 to 50 cm, from 5 to 40 cm, from 10 to 30 cm, or from 15 to 25 cm. However, it is to be appreciated that the cross-section may have any first diameter so long as the flange 30 and the lip 26 disengage from each other when the outer surface 16 is depressed from the relaxed position to the depressed position. The cross-section may have a second diameter adjacent the second end 40 in an amount of from 0.1 to 100 cm, from 1 to 50 cm, from 5 to 40 cm, from 10 to 30 cm, or from 15 to 25 cm. However, it is to be appreciated that the cross-section may have any second diameter so long as the flange 30 and the lip 26 disengage from each other when the outer surface 16 is depressed from the relaxed position to the depressed position. In exemplary embodiments, the first diameter is greater than the second diameter.

It is contemplated that the pop-top container assembly 10 is constructed of a material selected from the group consisting of: silicone, polyurethane, semi-rigid plastic, biocompatible materials, flexible plastic materials, composites, and foams. Other exemplary materials utilized for making the pop-top container assembly 10 comprise plastics such as polyphenysulphone, polystyrene, polypropylene, and/or polyethylene.

In preferred embodiments, the assembly 10 may include a compostable plastic. In various embodiments at least one of the pop-top cap 12 and the container 14 includes a compostable plastic. The compostable plastic may be selected from the group of polylactic acid, polybutylene adipate terephthalate, and a combination thereof. However, it is to be appreciated that the compostable plastic may be any plastic that is compostable over any period of time. The compostable plastic may be compostable as determined in accordance with ASTM-6400-99e1. To this end, in various embodiments, the assembly 10 is a certified composable product as determined in accordance with ASTM-6400-99e1. In exemplary embodiments, the compostable plastic is polylactic acid.

The compostable plastic has a thickness in an amount of from 0.01 to 100 mils, from 0.05 to 50 mils, from 0.1 to 10 mils, from 0.2 to 5 mils, or from 0.5 to 1.9 mils. The compostable plastic may have a flexural strength of from 1 to 200 MPa, as determined in accordance with ASTM D6272-17e1. However, it is to be appreciated that the compostable plastic may have any thickness so long as the flange 30 and the lip 26 disengage from each other when the outer surface 16 is depressed from the relaxed position to the depressed position. The compostable plastic exhibits a water vapor transmission rate of less than 100,000, less than 50,000, or less than 10,000, alternatively less than 1,000, less than 100, or less than 10, g/m²/24 hours, as determined in accordance with ASTM D6701-16. In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A pop-top container assembly, comprising:
a container and a pop-top cap;
the container having an outer surface and defining an internal cavity with the outer surface depressible between a relaxed position and a depressed position;
a pop-top cap comprising a base portion and a cap portion;
the base portion defining an opening having an inner surface with the base portion comprising a lip extending from the inner surface, and
the cap portion pivotably coupled to the base portion and pivotable between an open position and a closed position with the cap portion comprising a flange extending from the cap portion,
wherein the flange and the lip engage each other when the cap portion is in the closed position to secure the cap portion to the base portion; and
wherein the pop-top cap and the container cooperate to disengage the flange and the lip from each other when the outer surface is depressed from the relaxed position to the depressed position.

2. The pop-top container assembly of claim 1, wherein the base portion comprises an outer ring, an inner ring, and a plurality of linkages coupling the outer ring and inner ring together.

3. The pop-top container assembly of claim 2, wherein the plurality of linkages is adapted to flex in the presence of a force applied to the inner ring when the outer surface of the container is depressed from the relaxed position to the depressed position.

4. The pop-top container assembly of claim 2, wherein the lip of the base portion extends from the inner ring.

5. The pop-top container assembly of claim 2, wherein the outer ring defines a first void and a second void spaced from each other.

6. The pop-top container assembly of claim 5, wherein the container comprises a first tab and a second tab spaced from each other and extending away from the container.

7. The pop-top container assembly of claim 6, wherein the first and second voids and the first and second tabs are adapted to engage each other for securing the pop-top cap to the container.

8. The pop-top container assembly of claim 1, wherein at least one of the pop-top cap and the container comprises a compostable plastic.

9. The pop-top container assembly of claim 8, wherein the compostable plastic is selected from the group of polylactic acid, polybutylene adipate terephthalate, and a combination thereof.

10. The pop-top container assembly of claim 9, wherein the compostable plastic is polylactic acid.

11. The pop-top container assembly of claim 8, wherein the compostable plastic is compostable as determined in accordance with ASTM-6400-99e1.

12. The pop-top container assembly of claim 11, wherein the pop-top container assembly is a certified composable product as determined in accordance with ASTM-6400-99e1.

13. The pop-top container assembly of claim 8, wherein the compostable plastic has a flexural strength of from 1 to 200 MPa as determined in accordance with ASTM D6272-17e1.

14. The pop-top container assembly of claim 8, wherein the compostable plastic has a thickness in an amount of from 0.01 to 100 mils.

15. The pop-top container assembly of claim 1, wherein the container has a first end and a second end opposite the first end, and the outer surface is disposed between the first end and the second end.

16. The pop-top container assembly of claim 15, wherein the base is directly coupled to the container adjacent the first end.

17. The pop-top container assembly of claim 15, wherein the container has a length extending between the first end and the second end.

18. The pop-top container assembly of claim 15, wherein the container has a generally circular cross-section.

19. The pop-top container assembly of claim 18, wherein the cross-section has a first diameter adjacent the first end in an amount of from 0.1 to 10 centimeters and has a second diameter adjacent the second end in an amount of from 0.1 to 10 centimeters.

20. The pop-top container assembly of claim 18, wherein the first diameter is greater than the second diameter.
